(19) United States
(12) Patent Application Publication
(10) Pub. No.: US 2025/0389998 A1
(43) Pub. Date: Dec. 25, 2025

(54) DISPLAY DEVICE

(71) Applicant: Sharp Display Technology Corporation, Kameyama City (JP)

(72) Inventors: Kazuhiko IWASA, Kameyama City (JP); Yoshimasa Chikama, Kameyama City (JP); Yutaka Sawayama, Kameyama City (JP); Masamitsu Yamanaka, Kameyama City (JP); Shinji Nakajima, Kameyama City (JP)

(21) Appl. No.: 19/233,858

(22) Filed: Jun. 10, 2025

(30) Foreign Application Priority Data
Jun. 24, 2024 (JP) 2024-101108

(51) Int. Cl. G02F 1/167; G02F 1/1362; G02F 1/16766

(52) U.S. Cl. CPC G02F 1/167; G02F 1/136204; G02F 1/136254; G02F 1/16766; G02F 2202/22; G02F 2203/69

(57) ABSTRACT

A display device includes a first line extending along a first direction in a display area and a non-display area and a second line extending in the non-display area along a second direction crossing the first direction. The first and second lines are different portions of the first conductive film. The first line includes a first line section in the display area and a second line section in the non-display area. The second line section includes a first end portion, a first width portion, and a second width portion. The first end portion is spaced from the second line in the first direction. The first width portion is closer to the first line section with respect to the first direction than the first end portion is. The second width portion is continuous to the first width portion and narrower than the first width portion.

### CROSS REFERENCE TO RELATED APPLICATION

This application claims priority from Japanese Patent Application No. 2024-101108 filed on Jun. 24, 2024. The entire contents of the priority application are incorporated herein by reference.

### TECHNICAL FIELD

The present technology described herein relates to a display device in which line disconnection is less likely to be caused in a display area due to electrostatic discharge.

### BACKGROUND

There has been a display device including first electrode lines, a first electrode substrate, a second electrode substrate, and an optical modulation layer. The first electrode lines are disposed parallel to each other on a first insulating substrate. The first electrode substrate includes pixel electrodes that are arranged in a matrix and electrically connected to the first electrode lines, respectively, via switching components. The second electrode substrate is disposed on a second insulating substrate and includes an opposed electrode that is opposite the pixel electrodes. The optical modulation layer is held between the pixel electrodes and the opposed electrode. At least one of two first electrode lines that are adjacent to each other includes a discharge projection that projects toward the other one of the two first electrode lines.

In such a display device, the line includes a projecting portion as the discharge projection. The projecting portion is in a portion where a conductive pattern such as a signal line in a different layer is not formed. With such a configuration, a short circuit is less likely to occur between the scanning line or the auxiliary capacitance line and the conductive pattern such as the signal line in the different layer due to a damage in the insulating layer caused by the discharge. However, in the display device having the above configuration, each of the scanning line test pad and the auxiliary capacitance line connection and test pad that are adjacent to each other includes the projecting portion. Therefore, this technology may not be applied to a display device that does not include the configuration in which the two test pads are adjacent to each other. If the technology is not applied to a display device, disconnection may be caused in the line in the display area, in which an image is displayed, due to electrostatic discharge

### SUMMARY

The technology described herein was made in view of the above circumstances. An object is to achieve less occurrence of line disconnection in a display area due to electrostatic discharge.
(1) A display device according to the technology described herein includes a display area in which an image is displayed, a non-display area in which no image is displayed, a first line extending along a first direction in the display area and the non-display area, and a second line extending in the non-display area along a second direction that crosses the first direction. The first line is a portion of a first conductive film and the second line is a portion of the first conductive film that is different from the portion of the first conductive film. The first line includes a first line section that is disposed in the display area and a second line section that is disposed in the non-display area and is continuous to the first line section. The second line section includes a first end portion, a first width portion, and a second width portion. The first end portion is spaced from the second line in the first direction. The first width portion is closer to the first line section with respect to the first direction than the first end portion is. The second width portion is continuous to the first width portion and narrower than the first width portion.
(2) The display device may further include, in addition to (1), a third line disposed in the display area and extending along the second direction, and a first insulating film included in a layer upper than the first conductive film. The third line may be a portion of a second conductive film that is included in a layer upper than the first insulating film and the third line may cross the first line section via the first insulating film. The first insulating film may include a first contact hole in a portion that overlaps the third line and the first line section. The third line and the first line section may be connected via the first contact hole.
(3) The display device may further include, in addition to (1) or (2), a test line disposed in the non-display area and extending along the first direction and transmitting a test signal, and a first insulating film included in a layer upper than the first conductive film. The second line may include a pair of second lines, the test line may include a pair of test lines, and the second line section may include a pair of second line sections. Each of the pair of second lines, the pair of test lines, and the pair of second line sections may be disposed to sandwich the display area with respect to the first direction. The pair of second line sections may include first end portions. The pair of test lines may be portions of a second conductive film that is included in a layer upper than the first insulating film. The pair of test lines may cross the pair of second lines via the first insulating film, respectively, and include second end portions overlapping the first end portions. The first insulating film may include second contact holes in portions that overlap the first end portions and the second end portions, respectively. The first end portions and the second end portions may be respectively connected via the second contact holes.
(4) In the display device, in addition to any one of (1) to (3), the first line section may include a third width portion and a fourth width portion that is continuous to the third width portion and narrower than the third width portion.
(5) The display device may further include, in addition to (4), a fourth line disposed in the display area and extending along the second direction, and a first insulating film included in a layer upper than the first conductive film. The fourth line may be a portion of a second conductive film included in a layer upper than the first insulating film. The fourth line may cross the fourth width portion via the first insulating film.
(6) In the display device, in addition to any one of (1) to (5), the first width portion may include first width portions and the second width portion includes second width portions. The first width portions and the second width portions may be arranged alternately in the first direction.

According to the technology described herein, disconnection is less likely to be caused in a display area due to electrostatic discharge.

### BRIEF DESCRIPTION OF THE DRAWINGS

FIG. 1 is a plan view illustrating an electronic paper display according to one embodiment.

FIG. 2 is a circuit diagram illustrating an electrical configuration of an array substrate included in the electronic paper display.

FIG. 3 is a plan view illustrating pixel arrangement of the array substrate.

FIG. 4 is a cross-sectional view of the array substrate along iv-iv line in FIG. 3.

FIG. 5 is a cross-sectional view of the array substrate along v-v line in FIG. 3.

FIG. 6 is a cross-sectional view of the array substrate along vi-vi line in FIG. 3.

FIG. 7 is a cross-sectional view of the array substrate along vii-vii line in FIG. 3.

FIG. 8 is a plan view illustrating pixel arrangement of the array substrate and particularly

FIG. 9 is a plan view illustrating pixel arrangement of the array substrate and a configuration of a first metal film.

FIG. 10 is a plan view illustrating pixel arrangement of the array substrate and a configuration of a second metal film.

### DETAILED DESCRIPTION

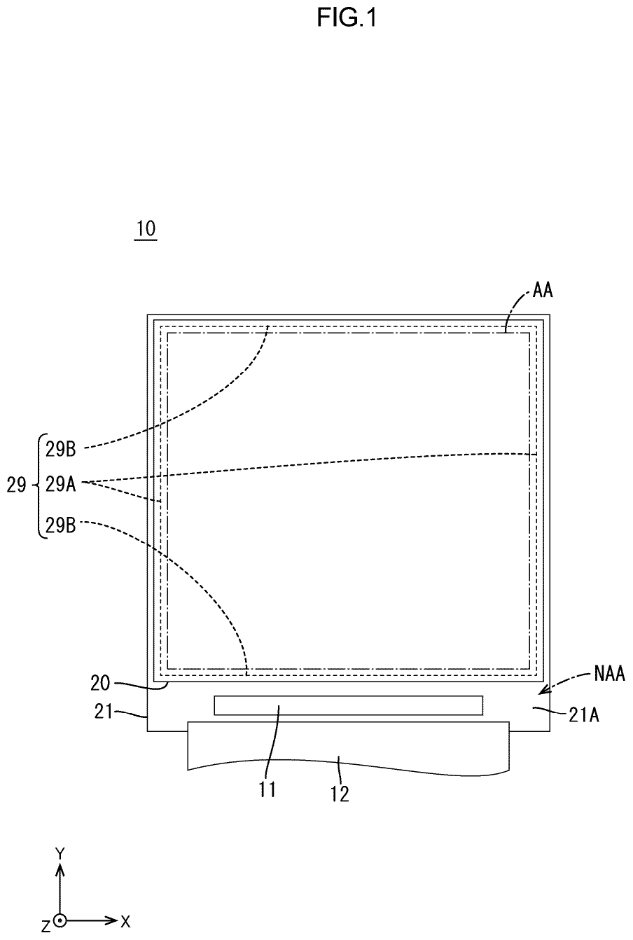

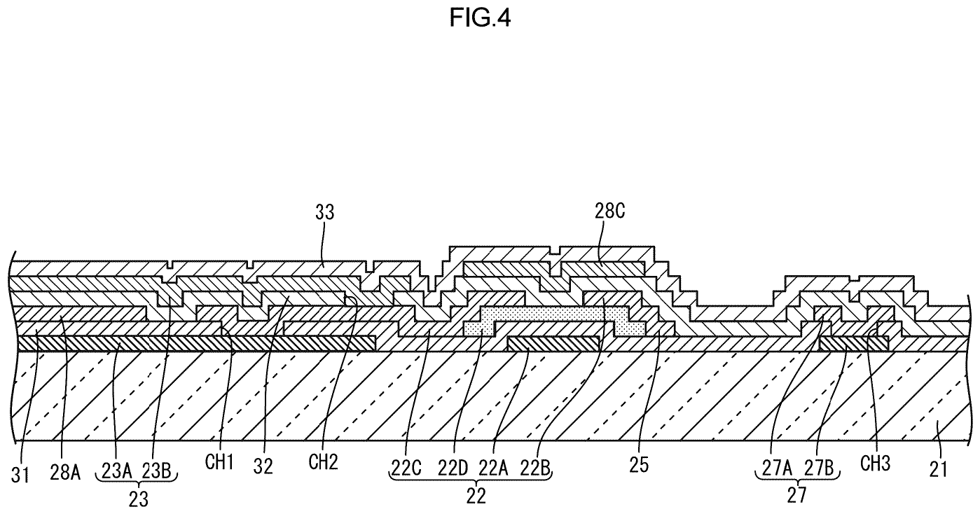

One embodiment will be described with reference to FIGS. 1 to 10. An electronic paper display 10 (a display device, EPD) will be described. X-axes, Y-axes, and Z-axes may be present in the drawings. The axes in each drawing correspond to the respective axes in other drawings. An upper side and a lower side in FIGS. 4 to 7 correspond to a front side and a back side of the electronic paper display 10, respectively.

As illustrated in FIG. 1, the electronic paper display 10 has a vertically long rectangular shape. The electronic paper display 10 of this embodiment is a microcapsule-based electrophoretic display. A middle section of a surface of the electronic paper display 10 is configured as a display area AA in which images are displayed. An outer section in a frame shape surrounding the display area AA in the surface of the electronic paper display 10 is configured as a non-display area NAA in which images are not displayed.

As illustrated in FIG. 1, the electronic paper display 10 includes an array substrate 21, which is a backplane, and an opposed substrate 20 that is opposite the array substrate 21 on the front side of the array substrate 21. The opposed substrate 20 is bonded to the array substrate 21. The opposed substrate 20 and the array substrate 21 include substrates (resin substrates) that are substantially transparent and made of synthetic resin. The electronic paper display 10 includes a microcapsule layer between the opposed substrate 20 and the array substrate 21. The microcapsule layer includes microcapsules in which charged particles are enclosed. The microcapsules at least include positively charged particles and negatively charged particles. The positively charged particles are positively charged and pigments exhibiting white. Titanium oxide particles are used as the positively charged particles. The negatively charged particles are negatively charged and pigments exhibiting black. Carbon black particles are used as the negatively charged particles. An opposed electrode is disposed on an inner surface side (on a surface opposite the array substrate 21) of the opposed substrate 20. The opposed electrode is made of transparent electrode material and is disposed in a solid manner to extend at least in an entire area of the display area on an inner surface of the opposed substrate 20.

As illustrated in FIG. 1, the opposed substrate 20 has a short-side dimension and a long-side dimension that are shorter than a short-side dimension and a long-side dimension of the array substrate 21. Particularly, the Y-axis dimension of the opposed substrate 20 is much shorter than that of the array substrate 21. The opposed substrate 20 is not in a center of the array substrate 21 and disposed to be closer to an upper edge of the array substrate 21. Therefore, the array substrate 21 includes a frame section 21A that does not overlap the opposed substrate 20. A lower edge section of the frame section 21A with respect to the Y-axis direction is wider than an upper edge section of the frame section 21A and is defined as a wide edge section. A driver 11 and a flexible substrate 12 for supplying various kinds of signals are mounted on the wide edge section of the frame section 21A of the array substrate 21. The non-display area NAA at least includes an entire area of the frame section 21A of the array substrate 21 and a section of the opposed substrate 20 surrounding the display area AA. The display area AA has a square shape that is slightly smaller than the opposed substrate 20. A capacitance main line 29 (a common main line) is disposed on a portion of the array substrate 21 that overlaps the opposed substrate 20. The capacitance main line 29 extends in a frame shape that is slightly larger than the display area AA and slightly smaller than the opposed substrate 20. The capacitance main line 29 includes two first main line sections 29A (a second line) that extend along the Y-axis direction and two second main line sections 29B that extend along the X-axis direction. Two ends of each first main line section 29A are connected to the ends of the respective two second main line sections 29B.

The driver 11 is an LSI chip including a driver circuit therein. The driver 11 processes the various kinds of signals transmitted from the flexible substrate 12. The driver 11 is mounted on the wide edge section of the frame section 21A of the array substrate 21. As illustrated in FIG. 1, the driver 11 is disposed adjacent to a lower edge of the display area AA with respect to the Y-axis direction and is between the flexible substrate 12 and the display area AA in the Y-axis direction. The driver 11 has a laterally long rectangular plan view shape. The driver 11 is a component for supplying various kinds of signals to lines of the array substrate 21. The flexible substrate 12 includes a substrate made of synthetic resin (e.g., polyimide-based resin) having insulating properties and flexibility and multiple traces formed on the substrate. A first end of the flexible substrate 12 is connected to the wide edge section of the frame section 21A of the array substrate 21 and a second end of the flexible substrate 12 is connected to an external circuit board (a control board).

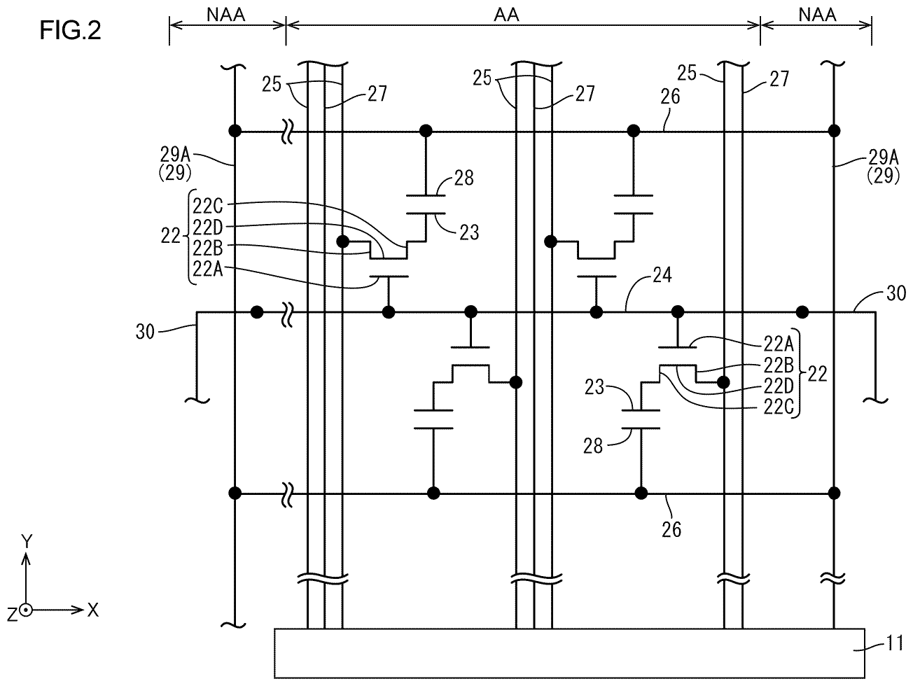

Next, an electrical configuration of the array substrate 21 will be described with reference to FIG. 2. As illustrated in FIG. 2, thin film transistors (TFTs) 22 (switching components) and pixel electrodes 23 are at least arranged in an area of an inner surface of the array substrate 21 in the display area AA. The TFTs 22 and the pixel electrodes 23 are arranged at intervals in a matrix (rows and columns) along the X-axis direction and the Y-axis direction. Gate lines 24 (first lines, scanning lines) and source lines 25 (fourth lines, image lines, signal lines), capacitance branch lines 26, and gate connection lines 27 (third lines) are routed perpendicular to each other (with crossing) to surround the TFTs 22 and the pixel electrodes 23. The TFT 22 includes a gate electrode 22A that is connected to the gate line 24, a source electrode 22B that is connected to the source line 25, a drain electrode 22C that is connected to the pixel electrode 23, and a semiconductor section 22D that is connected to the source electrode 22B and the drain electrode 22C. The TFTs 22 are driven based on scan signals supplied to the gate electrodes 22A through the gate lines 24. The scan signals include a potential higher than threshold voltage of the TFT 22. Through the driving of the TFT 22, a potential related to the image signal that is supplied to the source electrode 22B through the source line 25 is supplied to the drain electrode 22C via the semiconductor section 22D. As a result, the pixel electrode 23 is charged at the potential related to the pixel signal. Capacitance electrodes 28 are disposed on the inner surface side of the array substrate 21 in the display area AA. An electrostatic capacity is created between the capacitance electrode 28 and the pixel electrode 23. The capacitance main line 29 and a test line 30 are disposed on the inner surface side of the array substrate 21 in the non-display area NAA.

As illustrated in FIG. 2, the gate lines 24 and the capacitance branch lines 26 extend substantially along the X-axis direction (a first direction) and are arranged alternately at intervals with respect to the Y-axis direction (a second direction crossing the first direction). The TFT 22 and the pixel electrode 23 are disposed between the gate line 24 and the capacitance branch line 26 that are adjacent to each other at an interval with respect to the Y-axis direction. Each of the number of the gate lines 24 and the number of the capacitance branch lines 26 is about a half of the number of the pixel electrodes 23 arranged in the Y-axis direction. The gate line 24 extends in both of the display area AA and the non-display area NAA and is connected to the gate electrode 22A of the TFT 22 in the display area AA. The gate line 24 is connected to the gate electrode 22A of the TFT 22 that is connected to the pixel electrode 23 on the upper side (in FIG. 2) of the gate line 24 and connected to the gate electrode 22A of the TFT 22 that is connected to the pixel electrode 23 on the lower side (in FIG. 2) of the gate line 24. Namely, scan signals are supplied via one gate line 24 to the gate electrodes 22A of the TFTs 22 that are connected to the pixel electrodes 23 of two rows that are adjacent to each other in the Y-axis direction. Ends of the gate lines 24 that are on the non-display area NAA are connected to the test line 30.

The test line 30 extends from a connection portion of the test line 30 and the gate line 24 in the non-display area NAA to a test terminal that is on a predefined portion of the non-display area NAA and the test line 30 is connected to the test terminal. A test signal is input to the test terminal from a test pad included in an external test device. The test signal inputted to the test terminal is supplied to the gate line 24 via the test line 30. Based on the test signal, it can be tested whether the gate line 24 is disconnected. Two test lines 30 are disposed to sandwich the display area AA with respect to the X-axis direction. The two test lines 30 are respectively connected to the two ends of the gate line 24 with respect to the X-axis direction. Therefore, the test signals are supplied to the gate line 24 from the two test lines 30. The number of the test lines 30 is twice as the number of the gate lines 24.

As illustrated in FIG. 2, the capacitance branch line 26 extends in the display area AA and the non-display area NAA and is connected to the capacitance electrode 28 in the display area AA. An end of the capacitance branch line 26 that is on the non-display area NAA is connected to the first main line section 29A of the capacitance main line 29. The first main line section 29A extends along the Y-axis direction. All the capacitance branch lines 26 that are arranged at intervals in the Y-axis direction are connected to the first main line section 29A. A predetermined reference potential signal is supplied to the capacitance branch lines 26 from the first main line section 29A. Therefore, the reference potential signal is supplied to the capacitance electrode 28 from the first main line section 29A via the capacitance branch line 26. The capacitance main line 29 is connected to the driver 11 or the flexible substrate 12 and is supplied with the reference potential signal from the driver 11 or an external circuit board. Electrostatic capacity is created between the capacitance electrode 28 that is supplied with the reference potential signal from the capacitance branch line 26 and the pixel electrode 23. Thus, the potential of the charged pixel electrode 23 can be held. Two first main line sections 29A are disposed to sandwich the display area AA with respect to the X-axis direction. Two ends of the capacitance branch line 26 with respect to the X-axis are respectively connected to the two first main line sections 29A. Therefore, the reference potential signal can be supplied to the capacitance branch line 26 from the two first main line sections 29A.

As illustrated in FIG. 2, the source lines 25 and the gate connection lines 27 extend along the Y-axis direction. Two source lines 25 are disposed between every two pixel electrodes 23 that are adjacent to each other in the X-axis direction. The source line 25 is also disposed between the pixel electrode 23, which is in an edge portion of the display area AA in the X-axis direction, and the non-display area NAA. Therefore, the number of the source lines 25 is about twice as that of the pixel electrodes 23 that are arranged in the X-axis direction. Namely, the number of the source lines 25 is about twice as that of the pixel electrodes 23 that are included in one row along the X-axis direction. The source lines 25 extend in the display area AA and the non-display area NAA. Ends of the source lines 25 that are in the non-display area NAA are connected to the driver 11. The source lines 25 are supplied with image signals from the driver 11.

As illustrated in FIG. 2, the gate connection line 27 is disposed between every two pixel electrodes 23 that are adjacent to each other in the X-axis direction. The gate connection line 27 is also disposed close to the source line 25 that is in the edge portion of the display area AA in the X-axis direction. Namely, the gate connection line 27 near the edge portion of the display area AA is disposed between the source line 25, which is near the edge portion of the display area AA, and the non-display area NAA. The number of the gate connection lines 27 is about same as that of the pixel electrodes 23 that are arranged in the X-axis direction. The number of the gate connection lines 27 is at least same as or greater than the number of the gate lines 24. The gate connection lines 27 extend in the display area AA and the non-display area NAA. The gate connection lines 27 are connected to the gate line 24 in the display area AA. Each of all the gate lines 24 disposed in the display area AA is connected to one or more gate connection lines 27. Ends of the gate connection lines 27 that are in the non-display area NAA are connected to the driver 11. The gate connection lines 27 are supplied with scan signals from the driver 11. Therefore, the gate lines 24 are supplied with scan signals from the driver 11 via the gate connection lines 27.

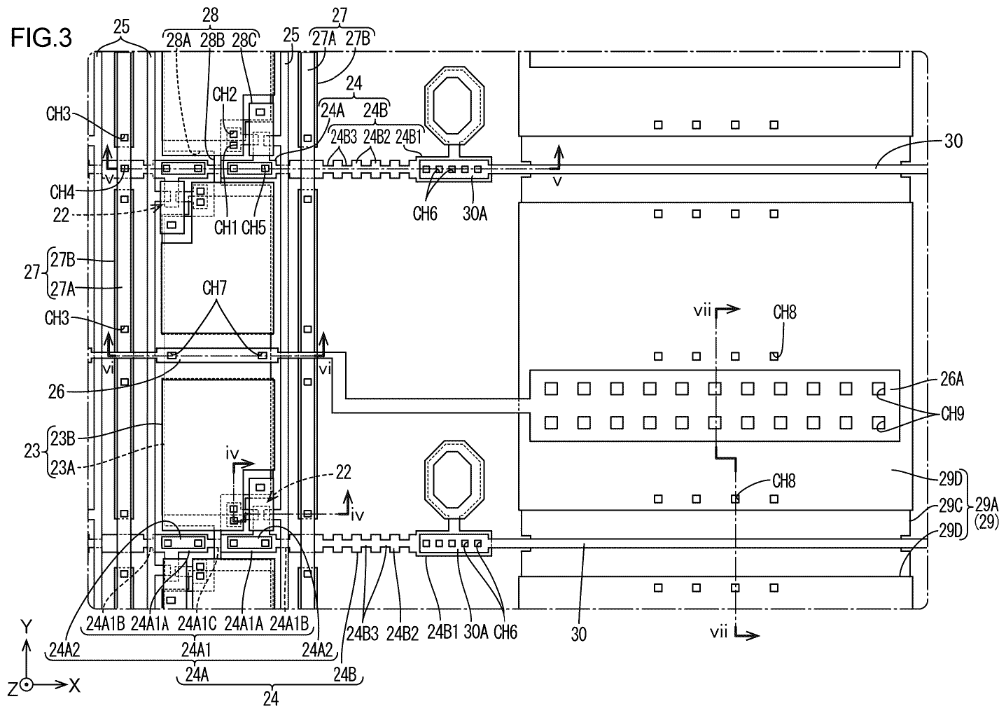

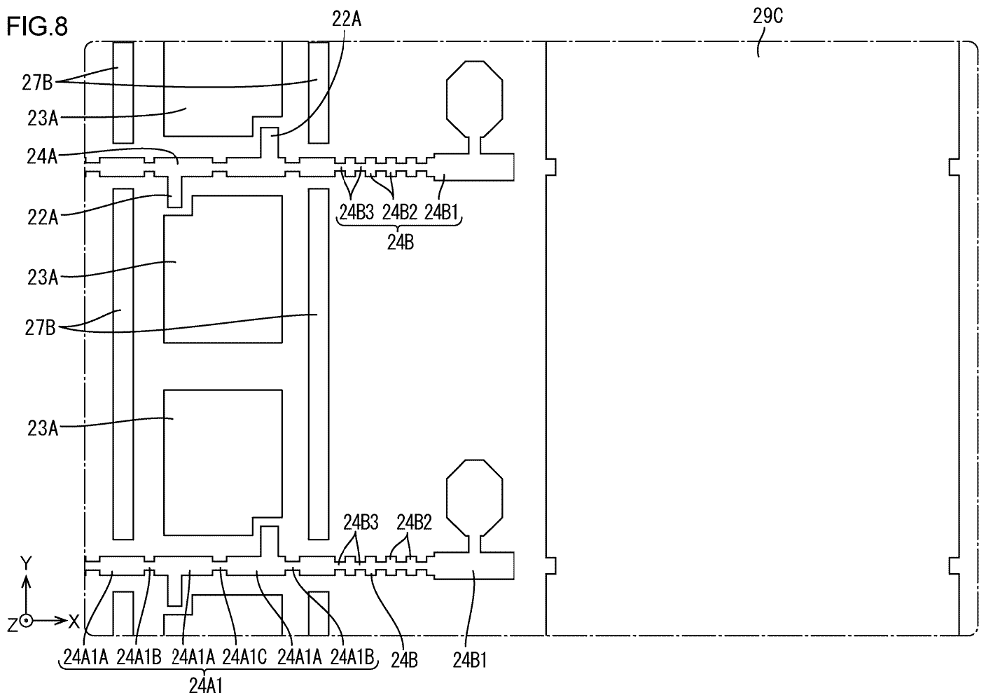

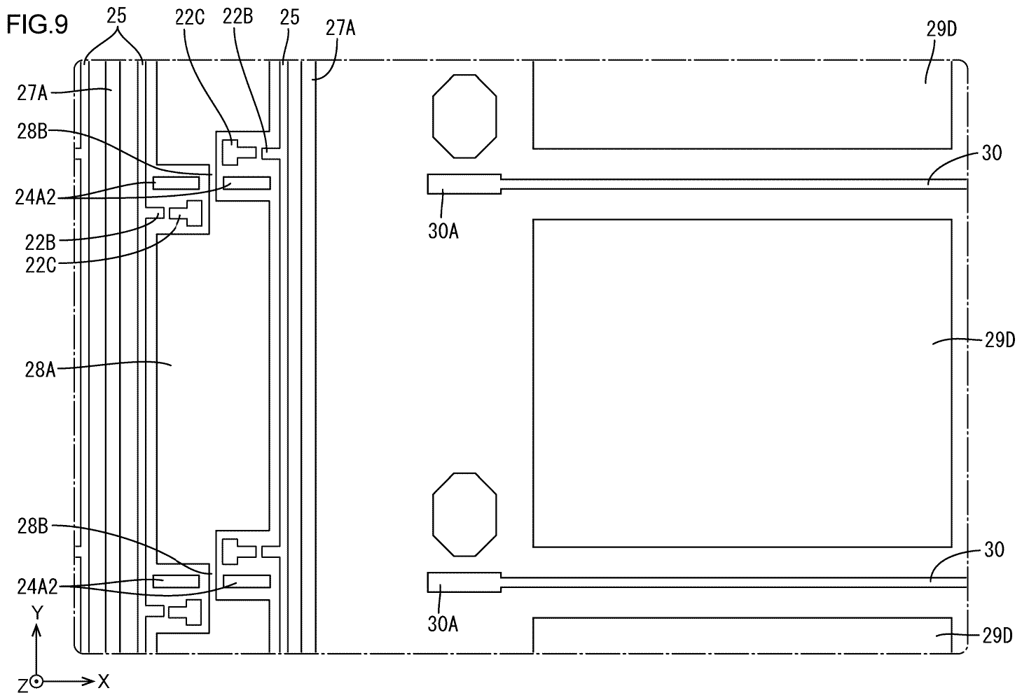

A detailed planar configuration of the array substrate 21 will be described with reference to FIG. 3. As illustrated in FIGS. 3 and 8, the gate electrode 22A of the TFT 22, which is disposed in the display area AA of the array substrate 21, extends along the Y-axis direction from a portion of the gate line 24 near a crossing portion where the gate line 24 and the source line 25 cross. As illustrated in FIG. 9, the source electrode 22B of the TFT 22 extends along the X-axis direction from a portion of the source line 25 near the crossing portion where the gate line 24 and the source line 25 cross. The source electrode 22B is one end portion of the TFT 22 in the X-axis direction. The source electrode 22B overlaps a portion of the gate electrode 22A and is connected to the semiconductor section 22D.

As illustrated in FIG. 9, the drain electrode 22C of the TFT 22 is disposed spaced from the source electrode 22B in the X-axis direction. The drain electrode 22C is another end portion of the TFT 22 in the X-axis direction. The drain electrode 22C extends along the X-axis direction. As illustrated in FIG. 2, one end of the drain electrode 22C close to the source electrode 22B is disposed to overlap a portion of the gate electrode 22A and is connected to the semiconductor section 22D. Another end of the drain electrode 22C opposite from the source electrode 22B is connected to the pixel electrode 23. The semiconductor section 22D of the TFT 22 has a laterally long rectangular shape extending along the X-axis direction. As illustrated in FIG. 4, the semiconductor section 22D overlaps the gate electrode 22A in a plan view. One end portion of the semiconductor section 22D in the X-axis direction is connected to the source electrode 22B and another end portion of the semiconductor section 22D in the X-axis direction is connected to the drain electrode 22C. The TFTs 22 include a TFT 22 that is on the upper side of the gate line 24 in FIG. 3 and a TFT 22 that is on the lower side of the gate line 24 in FIG. 3. The TFTs 22 on the upper side and the lower side have configurations that are inverted with respect to the upper-bottom direction and the right-left direction.

The pixel electrode 23 disposed in the display area AA of the array substrate 21 is arranged in an area surrounded by the gate line 24, the capacitance branch line 26, and the two source lines 25 as illustrated in FIGS. 2 and 3. The pixel electrode 23 has a vertically long rectangular shape. The pixel electrode 23 has good light reflectivity and is disposed opposite the opposed electrode, which is included in the opposed substrate 20 (refer to FIG. 1), via the microcapsule layer. With the pixel electrode 23 being charged, the charged particles move within the microcapsule according to the polarity and the potential of the pixel electrode 23. Light entering the microcapsule layer via the opposed substrate 20 from the outside of the electronic paper display 10 passes through or is absorbed by the charged particles that are arranged closer to the opposed substrate 20 within the microcapsule with respect to the Z-axis direction. Accordingly, the amount of reflecting light is controlled for each pixel electrode 23 and a predetermined image is displayed in the display area AA. With color filters being included in the opposed substrate 20, color images are displayed.

As illustrated in FIG. 3, the capacitance electrode 28 extends along the Y-axis direction and is disposed to overlap in a plan view the pixel electrodes 23 that are arranged along the Y-axis direction. The capacitance electrode 28 extends along the Y-axis direction and has a length corresponding to an entire length of the display area AA along the Y-axis direction. The capacitance electrode 28 overlaps all the pixel electrodes 23 that are included in one row. Specifically, the capacitance electrode 28 includes a capacitance electrode body 28A, a connection portion 28B, and a cover portion 28C. The capacitance electrode body 28A overlaps two pixel electrodes 23 disposed between two gate lines 24 that are adjacent to each other at an interval in the Y-axis direction. The connection portion 28B is continuous from the capacitance electrode body 28A. The cover portion 28C is connected to the capacitance electrode body 28A and covers a portion of the TFT 22. The capacitance electrode body 28A extends along the Y-axis direction to straddle the two pixel electrodes 23 and crosses the capacitance branch line 26 extending along the X-axis direction. The capacitance electrode bodies 28A are arranged in the Y-axis direction at intervals each of which corresponds to the size of the connection portion 28B. The connection portions 28B are arranged in the Y-axis direction at intervals each of which corresponds to the size of the capacitance electrode body 28A. The connection portion 28B connects the two capacitance electrode bodies 28A that are adjacent to each other at the interval in the Y-axis direction. The connection portion 28B is connected to a middle of the capacitance electrode body 28A with respect to the X-axis direction. The cover portion 28C has a connection portion that is connected to the capacitance electrode body 28A and extends from the connection portion along the Y-axis direction toward the TFT 22. The cover portion 28C at least covers the semiconductor section 22D of the TFT 22. The cover portion 28C has light blocking properties and blocks light. With the cover portion 28C, light is less likely to directly enter the semiconductor section 22D. Accordingly, the characteristics of the TFT 22 are less likely to be deteriorated. The capacitance electrodes 28 having such a configuration are arranged at intervals in the X-axis direction. The number of the capacitance electrodes 28 is same as the number of the pixel electrodes 23 arranged in the X-axis direction (the number of columns of the pixel electrodes 23).

As illustrated in FIG. 3, in the display area AA, the capacitance branch line 26 extends substantially straight along the X-axis direction and crosses all the capacitance electrodes 28 arranged in the X-axis direction. The capacitance branch line 26 is connected to all the capacitance electrodes 28 that are arranged in the X-axis direction. The capacitance branch line 26 is connected to the capacitance electrodes 28 that are included in one row. In the non-display area NAA, the capacitance branch line 26 extends to the first main line section 29A with being bent in a crank shape and is connected to the first main line section 29A. The first main line section 29A of the capacitance main line 29 extends substantially straight along the Y-axis direction and is connected to ends (connection portions 26A) of the capacitance branch lines 26 that extend along the X-axis direction. The first main line section 29A crosses the test line 30 extending along the X-axis direction.

As illustrated in FIG. 3, in the display area AA, the source line 25 and the gate connection line 27 extend substantially straight along the Y-axis direction and cross all the gate lines 24 and the capacitance branch lines 26 that are arranged in the Y-axis direction. The source line 25 is spaced from the pixel electrode 23 and the capacitance electrode 28 with respect to the X-axis direction. The gate connection line 27 is spaced from the source line 25 with respect to the X-axis direction and is farther away from the source line 25 than each of the pixel electrode 23 and the capacitance electrode 28 is. The gate connection line 27 is wider than the source line 25. The detailed configuration of the gate line 24 will be described later.

Films disposed on top of each other on the inner surface side of the array substrate 21 will be described with reference to FIG. 4. FIG. 4 is a cross-sectional view of a portion of the array substrate 21 including the TFT 22. As illustrated in FIG. 4, in the array substrate 21, a first metal film (a first conductive film), a gate insulating film 31 (a first insulating film), a semiconductor film, a second metal film (a second conductive film), a first interlayer insulating film 32 (a second insulating film), a third metal film (a third conductive film), and a second interlayer insulating film 33 are at least disposed on top of each other in this sequence from a lower layer side (from the resin substrate side).

The first metal film, the second metal film, and the third metal film may be a single-layer film made of one kind of metal, a multilayer film made of a material containing different kinds of metals, or an alloy. Examples of the metals include copper, titanium, aluminum, molybdenum, and tungsten. With such a configuration, the first metal film, the second metal film, and the third metal film have electrically conductive properties and light blocking properties. Portions of the first metal film are configured as portions of the pixel electrodes 23, portions of the gate lines 24, the gate electrodes 22A of the TFTs 22, portions of the gate connection lines 27, and portions of the capacitance main lines 29. Portions of the second metal film are configured as portions of the gate lines 24, the source lines 25, the source electrodes 22B and the drain electrodes 22C of the TFTs 22, portions of the gate connection lines 27, portions of the capacitance electrodes 28, portions of the capacitance main line 29, and the test lines 30. Portions of the third metal film are configured as portions of the pixel electrodes 23, the capacitance branch lines 26, and portions of the capacitance electrodes 28.

The semiconductor film is made of an oxide semiconductor material and the semiconductor sections 22D of the TFTs 22 are portions of the semiconductor film. The semiconductor film may include at least one kind of metallic elements out of In, Ga, and Zn and may be an In—Ga—Zn—O semiconductor (for example, In—Ga—Zn oxide). The In—Ga—Zn—O semiconductor is ternary oxide of indium (In), gallium (Ga), and zinc (Zn). A ratio (composition ratio) of indium (In), gallium (Ga), and zinc (Zn) is not particularly limited and may be In:Ga:Zn=2:2:1, In:Ga:Zn=1:1:1, and In:Ga:Zn=1:1:2, for example. The In—Ga—Zn—O semiconductor used for the semiconductor film may be amorphous or may be crystalline. The semiconductor film may include other oxide semiconductor instead of the In—Ga—Zn—O semiconductor. For example, the semiconductor film may include an In—Sn—Zn—O semiconductor (for example, In₂O₃-SnO₂-Zno; InSnZno). The In—Sn—Zn—O semiconductor is ternary oxide of indium (In), tin (Sn), and zinc (Zn). The oxide semiconductor layer may include an In—W—Zn—O semiconductor, an In—W—Sn—Zn—O semiconductor that include tungsten (W), an In—Al—Zn—O semiconductor, an In—Al—Sn—Zn—O semiconductor, a Zn—O semiconductor, an In—Zn—O semiconductor, a Zn—Ti—O semiconductor, a Cd—Ge—O semiconductor, a Cd—Pb—O semiconductor, cadmium oxide (CdO), a Mg—Zn—O semiconductor, an In—Ga—Sn—O semiconductor, an In—Ga—O semiconductor, a Zr—In—Zn—O semiconductor, a Hf—In—Zn—O semiconductor, an Al—Ga—Zn—O semiconductor, a Ga—Zn—O semiconductor, and an In—Ga—Zn—Sn—O semiconductor. The resistance value of the oxide semiconductor material of the semiconductor film with no application of a voltage (off state) is higher than that of polysilicon semiconductor material. The oxide semiconductor material of the semiconductor film has electron mobility higher than that of amorphous silicon semiconductor material.

The gate insulating film 31, the first interlayer insulating film 32, and the second interlayer insulating film 33 are made of an inorganic material such as silicon nitride (SiNₓ) and silicon oxide (SiO₂). The gate insulating film 31 insulates the first metal film in the lower layer from the semiconductor film and the second metal film in the upper layer. The first interlayer insulating film 32 insulates the semiconductor film and the second metal film in the lower layer from the third metal film in the upper layer. The second interlayer insulating film 33 covers the third metal film from the upper layer side.

Next, a cross-sectional configuration of the TFT 22 will be described. As illustrated in FIG. 4, the gate electrode 22A of the TFT 22 is a portion of the first metal film. The semiconductor section 22D of the TFT 22 is a portion of the semiconductor film. The semiconductor section 22D is included in a layer upper than the layer including the gate electrode 22A and overlaps the gate electrode 22A via the gate insulating film 31. The source electrode 22B of the TFT 22 is a portion of the second metal film and is directly contacted with a first end portion of the semiconductor section 22D with respect to the X-axis direction from the upper layer side. The drain electrode 22C of the TFT 22 is a portion of the second metal film and is directly contacted with a second end portion of the semiconductor section with respect to the X-axis direction from the upper layer side.

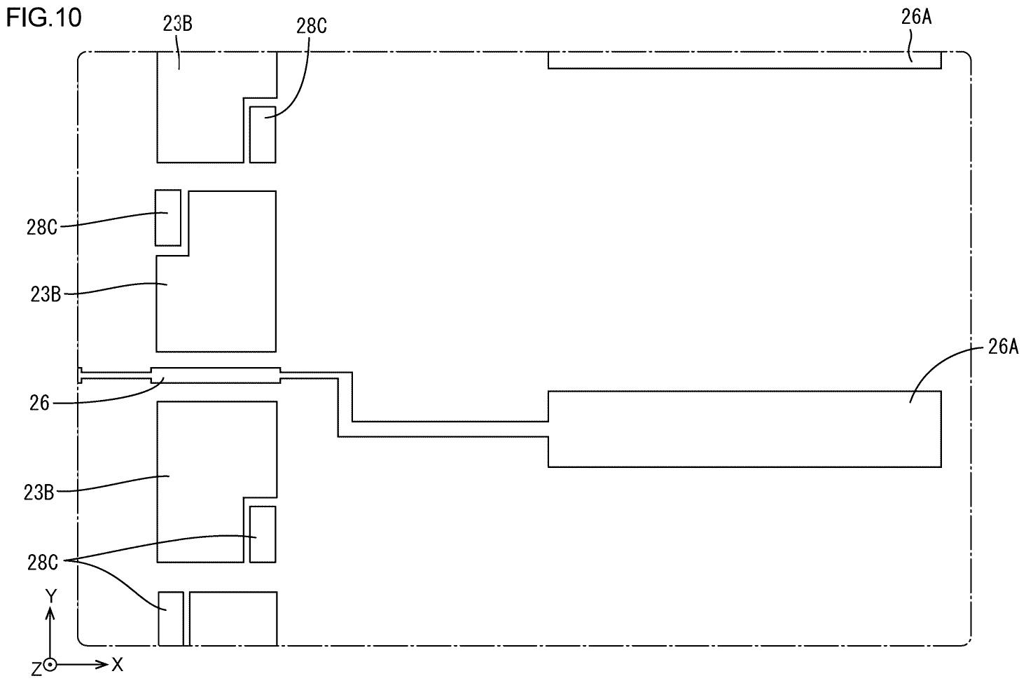

A cross-sectional configuration of the pixel electrode 23 will be described with reference to FIG. 4. As illustrated in FIGS. 4, 8, and 10, the pixel electrode 23 includes a lower layer electrode portion 23A that is a portion of the first metal film and an upper layer electrode portion 23B that is a portion of the third metal film. FIG. 8 is a plan view illustrating pixel arrangement of the array substrate and a plan view illustrating a configuration of the first metal film. FIG. 10 is a plan view illustrating pixel arrangement of the array substrate and a plan view illustrating a configuration of the third metal film. Most portions of the lower layer electrode portion 23A and the upper layer electrode portion 23B overlap. As illustrated in FIGS. 4 and 8, a portion of the lower layer electrode portion 23A overlaps a portion of an end portion of the drain electrode 22C that is on an opposite side from the source electrode 22B. The gate insulating film 31 that is disposed between the lower layer electrode portion 23A and the drain electrode 22C includes a first pixel contact hole CH1 in a portion overlapping the lower layer electrode portion 23A and the drain electrode 22C. The lower layer electrode portion 23A and the drain electrode 22C are connected via the first pixel contact hole CH1. As illustrated in FIGS. 4 and 10, a portion of the upper layer electrode portion 23B overlaps almost an entire area of the end portion of the drain electrode 22C that is on the opposite side from the source electrode 22B. The first interlayer insulating film 32 that is disposed between the upper layer electrode portion 23B and the drain electrode 22C includes a second pixel contact hole CH2 in a portion overlapping the upper layer electrode portion 23B and the drain electrode 22C and not overlapping the first pixel contact hole CH1. The upper layer electrode portion 23B and the drain electrode 22C are connected via the second pixel contact hole CH2. The first pixel contact hole CH1 and the second pixel contact hole CH2 are arranged at an interval in the Y-axis direction.

A cross-sectional configuration of the capacitance electrode body 28A of the capacitance electrode 28 will be described. As illustrated in FIGS. 4 and 9, the capacitance electrode body 28A is a portion of the second metal film. FIG. 9 is a plan view illustrating a pixel arrangement of the array substrate and is a plan view illustrating a configuration of the second metal film. The capacitance electrode body 28A overlaps the lower layer electrode portion 23A via the gate insulating film 31 and overlaps the upper layer electrode portion 23B via the first interlayer insulating film 32. Namely, the capacitance electrode body 28A is disposed between the lower layer electrode portion 23A and the upper layer electrode portion 23B in the Z-axis direction. An electrostatic capacity is created between the capacitance electrode body 28A and the lower layer electrode portion 23A and between the capacitance electrode body 28A and the upper layer electrode portion 23B. Therefore, the potential of the charged pixel electrode 23 can be effectively held. As illustrated in FIGS. 4 and 10, the cover portion 28C of the capacitance electrode 28 is a portion of the third metal film. The cover portion 28C overlaps the source electrode 22B, the drain electrode 22C, and the semiconductor section 22D via the first interlayer insulating film 32. The cover portion 28C effectively blocks light that is to enter the semiconductor section 22D (particularly a portion configured as a channel section).

Cross-sectional configurations of the source line 25 and the gate connection line 27 will be described. As illustrated in FIGS. 4 and 9, the source line 25 is a portion of the second metal film and is directly continuous to the source electrode 22B. As illustrated in FIGS. 4, 8, and 9, the gate connection line 27 includes a connection line body 27A that is a portion of the second metal film and an overlapping portion 27B that is a portion of the first metal film and overlaps the connection line body 27A. As illustrated in FIGS. 4 and 9, the connection line body 27A extends along the Y-axis direction and has a length corresponding to an almost entire length of the display area AA with respect to the Y-axis direction. As illustrated in FIGS. 4 and 8, the overlapping portion 27B extends along the Y-axis direction and extends in an area between the two gate lines 24 that are adjacent to each other with a space in the Y-axis direction. With such a configuration, a short circuit is less likely to occur between the overlapping portion 27B and the gate line 24. The overlapping portions 27B are arranged at intervals in the Y-axis direction and overlap one connection line body 27A via the gate insulating film 31. The gate insulating film 31 includes contact holes CH3 in portions respectively overlapping two end portions of the overlapping portion 27B in the Y-axis direction. The overlapping portion 27B is connected to the connection line body 27A at the two end portions thereof spaced from each other in the Y-axis direction via the two contact holes CH3. With such a configuration, redundancy of the gate connection line 27 can be obtained.

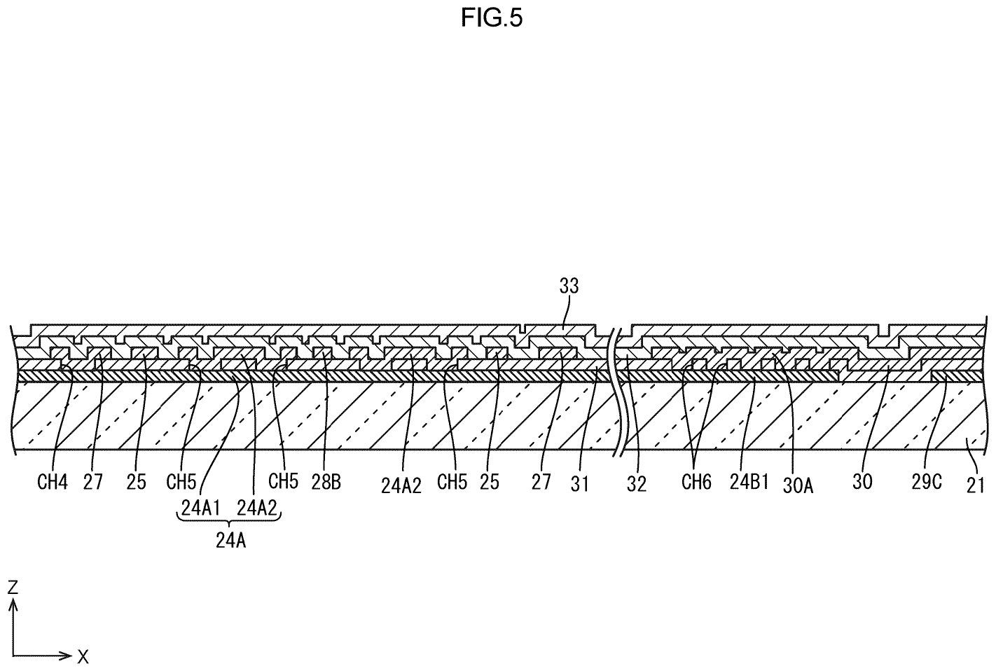

Next, cross-sectional configurations of the gate line 24 and the test line 30 will be described with reference to FIG. 5. FIG. 5 is a cross-sectional view of the gate line 24 and the test line 30 of the array substrate 21. As illustrated in FIG. 5, the gate line 24 includes a first line section 24A disposed in the display area AA and a second line section 24B disposed in the non-display area NAA. As illustrated in FIGS. 5, 8, and 9, the first line section 24A disposed in the display area AA includes a gate line body 24A1 that is a portion of the first metal film and an overlapping portion 24A2 that is a portion of the second metal film and overlaps the gate line body 24A1. As illustrated in FIGS. 5 and 8, the gate line body 24A1 extends along the X-axis direction and has a length corresponding to an almost entire length of the display area AA in the X-axis direction and crosses the source line 25 and the connection line body 27A of the gate connection line 27 via the gate insulating film 31. The gate insulating film 31 includes a gate connection contact hole CH4 (a first contact hole) in a portion overlapping the gate line body 24A1 and the connection line body 27A that are to be connected. The gate line body 24A1 of the gate line 24 is connected to the connection line body 27A of the gate connection line 27, which is to be connected, via the gate connection contact hole CH4. The gate connection contact hole CH4 is not formed in a portion of the gate insulating film 31 that overlaps the gate line body 24A1 and the connection line body 27A that are not to be connected.

As illustrated in FIGS. 5 and 9, the overlapping portion 24A2 extends along the X-axis direction and is disposed only in the area that is between the source line 25 and the connection portion 28B of the capacitance electrode 28 that are arranged at an interval in the X-axis direction. The connection portion 28B of the capacitance electrode 28 is a portion of the second metal film and crosses the gate line body 24A1 via the gate insulating film 31. With such a configuration, a short circuit is less likely to occur between the overlapping portion 24A2 and the source line 25 and between the overlapping portion 24A2 and the connection portion 28B. Two overlapping portions 24A2 are arranged in the X-axis direction to sandwich the connection portion 28B of the capacitance electrode 28 therebetween. The two overlapping portions 24A2 are disposed to overlap one gate line body 24A1 via the gate insulating film 31. The gate insulating film 31 includes contact holes CH5 in portions respectively overlapping the two end portions of the overlapping portion 24A2 with respect to the X-axis direction. The overlapping portion 24A2 is connected to the gate line body 24A1 via the two contact holes CH5. The overlapping portion 24A2 and the gate line body 24A1 are connected at two portions that are spaced from each other in the X-axis direction. Accordingly, redundancy of the first line section 24A can be obtained.

As illustrated in FIGS. 5 and 8, the second line sections 24B that are disposed in the non-display area NAA are portions of the first metal film. The second line sections 24B extend along the X-axis direction in the non-display area. Display area side end portions of the second line sections 24B that are close to the display area AA in the X-axis direction are continuous to the end portions of the gate line bodies 24A1 of the first line sections 24A, respectively. End portions of the second line sections 24B that are opposite from the display area side end portions in the X-axis direction are defined as first end portions 24B1 that are connected to the test lines 30. The first end portion 24B1 is spaced from the capacitance main line 29 (the first main line section 29A) in the X-axis direction. The first end portion 24B1 is wider than other portion of the second line section 24B (a first width portion 24B2 and a second width portion 24B3). As illustrated in FIGS. 5 and 9, the test lines 30 are portions of the second metal film. The test lines 30 extend along the X-axis direction and cross the first main line section 29A of the capacitance main line 29. Display area side end portions of the test lines 30 in the X-axis direction overlap the first end portions 24B1 of the second line sections 24B, respectively, and are defined as second end portions 30A that are respectively connected to the first end portions 24B1. The second end portion 30A is wider than other portion of the test line 30. The gate insulating film 31 includes a test connection contact hole CH6 (a second contact hole) in a portion overlapping the first end portion 24B1 and the second end portion 30A. The first end portion 24B1 of the second line section 24B is connected to the second end portion 30A of the test line 30 via the test connection contact hole CH6. The test connection contact holes CH6 are arranged at intervals in the X-axis direction.

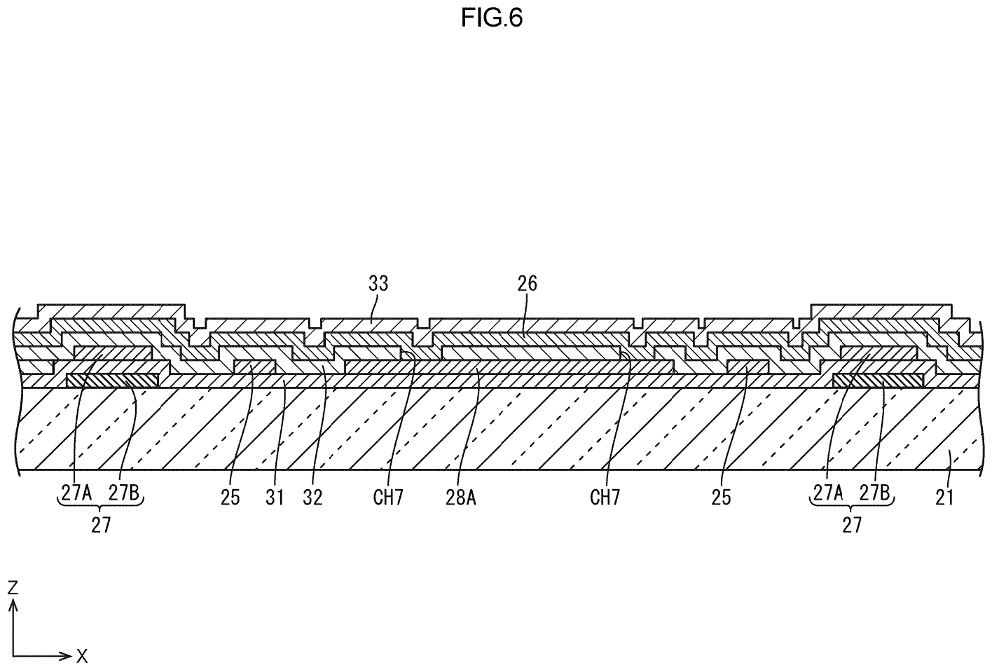

A cross-sectional configuration of the capacitance branch line 26 in the display area AA will be described with reference to FIG. 6. FIG. 6 is a cross-sectional view of the capacitance branch line 26 of the array substrate 21. As illustrated in FIGS. 6 and 10, the capacitance branch lines 26 are portions of the third metal film. In the display area AA, the capacitance branch lines 26 extend along the X-axis direction and cross the source lines 25, the gate connection lines 27, and the capacitance electrodes 28. The capacitance branch line 26 crosses the source lines 25 and the connection line bodies 27A of the gate connection lines 27 via the first interlayer insulating film 32 and crosses the overlapping portions 27B of the gate connection lines 27 via the gate insulating film 31. The capacitance branch line 26 includes a wide section that crosses the capacitance electrode body 28A and is wiser than portions of the capacitance branch line 26 that cross the source line 25 and the gate connection line 27. The first interlayer insulating film 32 includes a contact hole CH7 in a portion overlapping the capacitance branch line 26 and the capacitance electrode body 28A. The capacitance branch line 26 is connected to the capacitance electrode body 28A via the contact hole CH7. The first interlayer insulating film 32 includes two contact holes CH7 in portions corresponding to two end portions of the capacitance electrode body 28A in the X-axis direction.

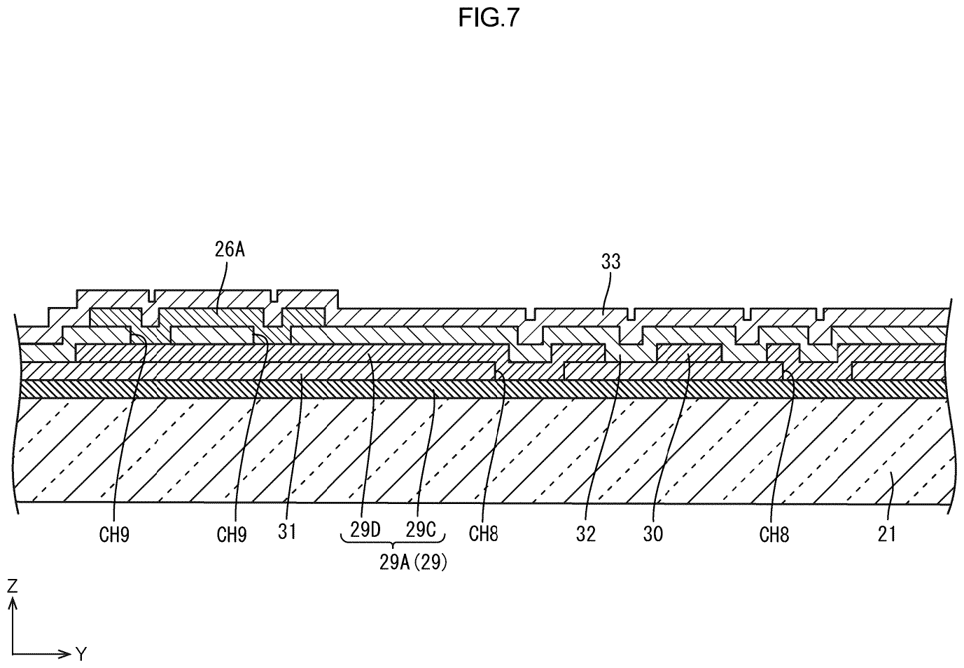

Cross-sectional configurations of the capacitance branch line 26 and the capacitance main line 29 in the non-display area NAA will be described with reference to FIG. 7. FIG. 7 is a cross-sectional view illustrating the capacitance branch line 26 and the capacitance electrode 28. As illustrated in FIGS. 7 to 9, the capacitance main line 29 includes a main line body 29C that is a portion of the first metal film and a connection electrode portion 29D that is a portion of the second metal film. In FIG. 7, the cross-sectional configuration of the first main line section 29A of the capacitance main line 29 is illustrated and the second main line section 29B (see FIG. 1) also has a cross-sectional configuration similar to that of the first main line section 29A. The portion of the main line body 29C that is configured as the first main line section 29A extends along the Y-axis direction and is longer than the Y-axis dimension of the display area AA. The portion of the main line body 29C configured as the first main line section 29A crosses the test line 30 via the gate insulating film 31. The connection electrode portion 29D extends along the Y-axis direction and is disposed only in the area that is between the two test lines 30 arranged at an interval in the Y-axis direction. Accordingly, a short circuit is less likely to occur between the connection electrode portion 29D and the test line 30. The connection electrode portions 29D are arranged at intervals in the Y-axis direction and overlap the main line body 29C via the gate insulating film 31. The gate insulating film 31 includes contact holes CH8 in portions that overlap the main line body 29C and the connection electrode portion 29D and correspond to a middle portion and two edge portions of the connection electrode portion 29D in the Y-axis direction. The connection electrode portion 29D is connected to the main line body 29C via the contact holes CH8. The contact holes CH8 are arranged at intervals in the X-axis direction.

As illustrated in FIGS. 7 and 10, in the non-display area NAA, the capacitance branch line 26 that is a portion of the third metal film is bent in a crank shape and extends along the X-axis direction to the first main line section 29A. The capacitance branch line 26 includes a connection portion 26A that overlaps the connection electrode portion 29D of the first main line section 29A via the first interlayer insulating film 32. The connection portion 26A is wider than other portion of the capacitance branch line 26. The first interlayer insulating film 32 includes a contact hole CH9 overlapping the connection portion 26A and the connection electrode portion 29D. The connection portion 26A is connected to the connection electrode portion 29D via the contact hole CH9. The first interlayer insulating film 32 includes two rows of contact holes CH9 that are arranged at an interval in the Y-axis direction. The contact holes CH9 included in one row are arranged at intervals in the X-axis direction.

As illustrated in FIG. 8, the second line section of the gate line 24 of this embodiment has a width (a dimension measured in the Y-axis direction) that varies from the first line section 24A side end portion to the first end portion 24B1. Specifically, the second line section 24B includes the first width portions 24B2 and the second width portions 24B3 that are narrower than the first width portions 24B2. The first width portions 24B2 and the second width portions 24B3 are between the first end portion 24B1 and the first line section 24A (the display area AA) in the X-axis direction. The first width portions 24B2 and the second width portions 24B3 are closer to the first line section 24A (the display area AA) than the first end portion 24B1 is in the X-axis direction. The first width portion 24B2 is narrower than the first end portion 24B1 and wider than the second width portion 24B3. The second width portion 24B3 is continuous to the first width portion 24B2 and a narrowest portion of the second line section 24B. The first width portion 24B2 and the second width portion 24B3 may have an almost same dimension measured in the X-axis direction.

As illustrated in FIG. 8, a width of the gate line body 24A1 of the first line section 24A of the gate line 24 varies as the gate line body 24A1 extends in the X-axis direction. The first line section 24A includes a third width portion 24A1A, a fourth width portion 24A1B that is narrower than the third width portion 24A1A, and a fifth width portion 24A1C that is narrower than the third width portion 24A1A. The third width portion 24A1A is a portion of the first line section 24A that does not cross the source line 25 and the connection portion 28B of the capacitance electrode 28. The third width portions 24A1A are arranged at intervals in the X-axis direction. Specifically, some of the third width portions 24A1A respectively overlap the overlapping potions 24A2 of the first line section 24A and some of the third width portions 24A1A cross the gate connection line 27. The third width portion 24A1A has substantially a same width as that of the first width portion 24B2. The fourth width portion 24A1B is a portion of the first line section 24A that crosses the source line 25 via the gate insulating film 31. The fifth width portion 24A1C is a portion of the first line section 24A that crosses the connection portion 28B of the capacitance electrode 28 via the gate insulating film 31. The third width portion 24A1A that overlaps the overlapping portion 24A2 is between the fourth width portion 24A1B and the fifth width portion 24A1C in the X-axis direction. The third width portion 24A1A that crosses the gate connection line 27 is between two fourth width portions 24A1B in the X-axis direction. The fourth width portion 24A1B and the fifth width portion 24A1C are continuous to the third width portion 24A1A. The fourth width portion 24A1B and the fifth width portion 24A1C have substantially a same width. The fourth width portion 24A1B and the fifth width portion 24A1C have a width substantially same as that of the second width portion 24B3.

As illustrated in FIG. 8, the portion of the gate line body 24A1 of the first line section 24A that crosses the source line 25 via the gate insulating film 31 is the fourth width portion 24A1B that is narrower than the third width portion 24A1A. With such a configuration, compared to a configuration in which the source line crosses the third width portion 24A1A, the parasitic capacitance that may be created between the gate line 24 and the source line 25 can be reduced. The portion of the gate line body 24A1 of the first line section 24A that crosses the connection portion 28B of the capacitance electrode 28 via the gate insulating film 31 is the fifth width portion 24A1C that is narrower than the third width portion 24A1A. With such a configuration, compared to a configuration in which the connection portion of the capacitance electrode crosses the third width portion 24A1A, the parasitic capacitance that may be created between the gate line 24 and the capacitance electrode 28 can be reduced.

In the process of producing the array substrate 21, the gate line body 24A1 of the first line section 24A of the gate line 24, the second line section 24B, and the first main line section 29A of the capacitance main line 29 may be formed with pattering the first metal film disposed on a resin substrate. With such a process, electrostatic discharge may be caused between the first main line section 29A and the first end portion 24B1 of the second line section 24B that are adjacent to each other at an interval in the X-axis direction. In this respect, the fourth width portion 24A1B and the fifth width portion 24A1C of the first line section 24A are narrower than the third width portion 24A1A in the display area AA. Therefore, with the electrostatic discharge being caused, electrostatic damage may be likely to be caused in the fourth width portion 24A1B and the fifth width portion 24A1C. If electrostatic damage is caused in the fourth width portion 24A1B and the fifth width portion 24A1C, the first line section 24A may be disconnected, a short circuit may occur between the fourth width portion 24A1B and the source line 25 or between the fifth width portion 24A1C and the capacitance electrode 28.

In this embodiment, as illustrated in FIG. 8, in the second line section 24B disposed in the non-display area NAA, the second width portion 24B3 is continuous to the first width portion 24B2, which is closer to the first line section 24A than the first end portion 24B1 is in the X-axis direction, and is narrower than the first width portion 24B2. Therefore, electrostatic damage is likely to be caused in the second width portion 24B3 due to the electrostatic discharge. Accordingly, in the gate line 24, electrostatic damage is less likely to be caused in the fourth width portion 24A1B and the fifth width portion 24A1C of the first line section 24A disposed in the display area AA. Disconnection of the first line section 24A is less likely to be caused due to the electrostatic discharge. A short circuit is less likely to occur between the fourth width portion 24A1B and the source line 25 and between the fifth width portion 24A1C and the capacitance electrode 28.

As illustrated in FIG. 8, the second line section 24B of this embodiment includes the first width portions 24B2 and the second width portions 24B3. The first width portions 24B2 and the second line portions 24B3 are arranged alternately in the X-axis direction in an area between the first line section 24A side end portion and the first end portion 24B1 of the second line section 24B. With such a configuration, electrostatic damage due to the electrostatic discharge is caused in the second width portions 24B3. Accordingly, in the gate line 24, electrostatic damage is further less likely to be caused in the fourth width portions 24A1B and the fifth width portions 24A1C of the first line section 24A in the display area AA. Therefore, disconnection of the gate line 24 is further less likely to be caused in the display area AA and a short circuit is further less likely to occur between the gate line 24 and the source line 25 and between the gate line 24 and the capacitance electrode 28.

In this embodiment, as illustrated in FIGS. 3 and 5, the gate connection line 27 for transmitting the scan signals from the driver 11 is connected to the first line section 24A of the gate line 24, which is arranged in the display area AA, via the gate connection contact hole CH4 of the gate insulating film 31. Therefore, the scan signals can be supplied to the first line section 24A via the gate connection line 27 and without being transferred via the second line section 24B. Accordingly, electrostatic damage is caused in the second width portion 24B3 of the second line section 24B due to the electrostatic discharge. Even if the second line section 24B is disconnected, the scan signal can be supplied to the gate line 24.

In this embodiment, as illustrated in FIG. 2, a pair of test lines 30 for transmitting scan signals from the test device is disposed to sandwich the display area AA in the X-axis direction and a pair of second line sections 24B of the gate line 24 disposed in the non-display area NAA is disposed to sandwich the display area AA in the X-axis direction. As illustrated in FIGS. 2 and 5, the second end portions 30A of the pair of test lines 30 are respectively connected to the first end portions 24B1 of the pair of second line sections 24B via the test connection contact holes CH6. Therefore, if electrostatic damage is caused in the second width portion 24B3 of one of the pair of second line sections 24B due to the electrostatic discharge and the one of the pair of second line sections 24B is disconnected, the other one of the pair of second line sections 24B can be supplied with test signals from the test line 30 connected to the other one of the pair of second line sections 24B. Accordingly, test signals can be supplied to the gate line 24.

As previously described, the electronic paper display 10 (the display device) of this embodiment includes the display area AA in which images are displayed, the non-display area NAA in which images are not displayed, the gate line 24 (the first line) that is disposed in the display area AA and the non-display area NAA and extends along the first direction, and the first main line section 29A (the second line) that extends along the second direction crossing the first direction. The gate line 24 and the first main line section 29A are different portions of the first metal film (the first conductive film). The gate line 24 includes the first line section 24A that is disposed in the display area AA and the second line section 24B that is disposed in the non-display area NAA and is continuous to the first line section 24A. The second line section 24B includes the first end portion 24B1, the first width portion 24B2, and the second width portion 24B3. The first end portion 24B1 is spaced from the first main line section 29A in the first direction. The first width portion 24B2 is closer to the first line section 24A than the first end portion 24B1 is in the first direction. The second width portion 24B3 is continuous to the first width portion 24B2 and narrower than the first width portion 24B2.

The first end portion 24B1 of the second line section 24B of the gate line 24 extending along the first direction is spaced from the first main line section 29A that extends along the second direction crossing the first direction. The first end portion 24B1 and the first main line section 29A are spaced from each other in the non-display area NAA with respect to the first direction. Therefore, with the gate line 24 and the first main line section 29A being formed with pattering the first metal film, electrostatic discharge may be caused between the first end portion 24B1 of the second line section 24B and the first main line section 29A. The second width portion 24B3, which is continuous to the first width portion 24B2 and closer to the first line section 24A than the first end portion 24B1 is in the first direction, is narrower than the first width portion 24B2. Therefore, electrostatic damage may be likely to be caused in the second width portion 24B3 due to the electrostatic discharge. Accordingly, electrostatic damage is less likely to be caused in the first line section 24A that is disposed in the display area AA and therefore, the gate line 24 is less likely to be disconnected in the display area AA due to the electrostatic discharge.

The electronic paper display 10 includes the gate connection line 27 (a third line) extending along the second direction and the gate insulating film 31 (a first insulating film) included in a layer upper than the first metal film. The gate connection line 27 is a portion of the second metal film (the second conductive film) that is included in a layer upper than the gate insulating film 31. The gate connection line 27 crosses the first line section 24A via the gate insulating film 31. The gate insulating film 31 includes the gate connection contact hole CH4 (the first contact hole) in a portion overlapping the gate connection line 27 and the first line section 24A. The gate connection line 27 and the first line section 24A are connected via the gate connection contact hole CH4. The gate connection line 27, which extends along the second direction, and the first line section 24A, which is a portion of the gate line 24, are connected in the display area AA via the gate connection contact hole CH4 of the gate insulating film 31. Therefore, signals are supplied to the gate line 24 via the gate connection line 27. Therefore, even if electrostatic damage is caused in the second width portion 24B3 of the second line section 24B of the gate line 24 due to the electrostatic discharge, the signals can be supplied to the gate line 24.

The electronic paper display 10 includes the test line 30 disposed in the non-display area NAA and extending along the first direction for transmitting test signals and the gate insulating film 31 included in a layer upper than the first metal film. Each of a pair of first main line sections 29A, a pair of test lines 30, and a pair of second line sections 24B is disposed to sandwich the display area AA with respect to the first direction. The pair of test lines 30 is portions of the second metal film that is included in a layer upper than the gate insulating film 31. The test lines 30 cross the first main line section 29A via the gate insulating film 31. The test lines 30 respectively include the second end portions 30A that respectively overlap the first end portions 24B1. The gate insulating film 31 includes the test connection contact hole CH6 (the second contact hole) in a portion overlapping the first end portion 24B1 and the second end portion 30A. The first end portion 24B1 and the second end portion 30A are connected via the test connection contact hole CH6. The test line 30 crosses the first main line section 29A via the gate insulating film 31. Therefore, a short circuit is less likely to occur between the test line 30 and the first main line section 29A. The test line 30 extending along the first direction and the second line section 24B of the gate line 24 are connected via the test connection contact hole CH6 of the gate insulating film 31 in the non-display area NAA. Therefore, test signals can be supplied to the gate line 24 via the test line 30. Each of a pair of first main line sections 29A, a pair of test lines 30, and a pair of second line sections 24B is disposed to sandwich the display area AA with respect to the first direction. The gate line 24 can be tested with using the pair of test lines 30. Therefore, even if electrostatic damage is caused in the second width portion 24B3 of one of the pair of second line sections 24B due to the electrostatic discharge, the gate line 24 can be tested with one of the pair of test lines 30.

The first line section 24A includes the third width portion 24A1A and the fourth width portion 24A1B that is continuous to the third width portion 24A1A and narrower than the third width portion 24A1A. In the display area AA, the fourth width portion 24A1B of the first line section 24A is narrower than the third width portion 24A1A. Therefore, electrostatic damage may be likely to be caused in the fourth width portion 24A1B due to the electrostatic discharge. In this respect, the second width portion 24B3 of the second line section 24B including the first end portion 24B1, which is spaced from the first main line section 29A in the first direction, is narrower than the first width portion 24B2 in the non-display area NAA. Therefore, electrostatic damage may be likely to be caused in the second width portion 24B3 due to the electrostatic discharge. Accordingly, electrostatic damage is less likely to be caused in the fourth width portion 24A1B of the first line section 24A disposed in the display area AA. Therefore, the gate line 24 is less likely to be disconnected in the display area AA due to the electrostatic discharge.

The electronic paper display 10 includes the source line 25 (a fourth line) disposed in the display area AA and extending along the second direction and the gate insulating film 31 included in a layer upper than the first metal film. The source line 25 is a portion of the second metal film included in a layer upper than the gate insulating film 31 and crosses the fourth width portion 24A1B via the gate insulating film 31. The source line 25 extending along the second direction in the display area AA crosses the fourth width portion 24A1B of the first line section 24A that is narrower than the third width portion 24A1A via the gate insulating film 31. With such a configuration, compared to a configuration in which the source line crosses the third width portion 24A1A, the parasitic capacitance that may be created between the gate line 24 and the source line 25 can be reduced. Electrostatic damage may be likely to be caused in the second width portion 24B3 due to the electrostatic discharge. Accordingly, electrostatic damage is less likely to be caused in the fourth width portion 24A1B. Therefore, a short circuit is less likely to occur between the source line 25 and the fourth width portion 24A1B, which cross, due to the electrostatic damage.

The second line section 24B includes the first width portions 24B2 and the second width portions 24B3. The first width portions 24B2 and the second line portions 24B3 are arranged alternately in the first direction. With the first width portions 24B2 and the second line portions 24B3 being arranged alternately the in first direction, electrostatic damage due to the electrostatic discharge is caused in the second width portions 24B3. Accordingly, in the gate line 24, electrostatic damage is further less likely to be caused in the first line section 24A disposed in the display area AA. Therefore, disconnection of the gate line 24 is further less likely to be caused in the display area AA.

### Other Embodiments

The technology described herein is not limited to the embodiments described above and illustrated by the drawings. For example, the following embodiments will be included in the technical scope of the present technology.
(1) The number of the first width portions 24B2 of the second line section 24B and the number of the second width portions 24B3 of the second line section 24B may be altered from the ones illustrated in the drawings.
(2) The X-axis dimension of the first width portion 24B2 and the second width portion 24B3 may be altered as appropriate from the one illustrated in the drawings. For instance, the X-axis dimension of the first width portion 24B2 may differ from the X-axis dimension of the second width portion 24B3.
(3) The capacitance main line 29 may not include the connection electrode portion 29D. In such a configuration, the connection portion 26A of the capacitance branch line 26 may be directly connected to the main line body 29C of the capacitance main line 29 via contact holes continuously formed in the gate insulating film 31 and the first interlayer insulating film 32.
(4) The gate line 24 may be disposed for every row of the pixel electrodes 23 that are arranged along the X-axis direction. In such a configuration, the number of gate lines 24 may be same as the number of rows of the pixel electrodes 23. The source line 25 may be disposed for every column of the pixel electrodes 23 that are arranged along the Y-axis direction. The number of source lines 25 may be same as the number of columns of the pixel electrodes 23. The capacitance branch line 26 may be disposed to overlap a predetermined one of the gate lines 24. The number of gate connection lines 27 may be altered according to the number of gate lines 24.
(5) In the above (4), with the number of source lines 25 and the number of gate connection lines 27 being altered, the number of each of the third width portions 24A1A, the fourth width portions 24A1B, and the fifth width portions 24A1C of the first line section 24A may be altered.
(6) The array substrate 21 may include a source driver that supplies image signals to the source lines 25 and a gate driver that supplies scan signals to the gate connection lines 27.
(7) Instead of the gate connection line 27 that vertically extends in the display area AA, gate connection line that is connected to the first end portion 24B1 of the second line section 24B may be disposed in the non-display area NAA. In such a configuration, the array substrate 21 may include a pair of gate driver circuits that sandwich the display area AA in the X-axis direction and a pair of gate connection lines each of which is disposed between the display area AA and the gate driver circuit. The gate connection line may extend along the X-axis direction from the gate driver circuit to the first end portion 24B1 of the second line section 24B. With such a configuration, by supplying scan signals to the gate connection line from the gate driver circuit, the scan signals may be supplied to the gate line 24 via the gate connection line. Even if the second width portion 24B3 of one of the pair of second line sections 24B is disconnected due to electrostatic damage, the scan signals from the gate connection line can be supplied to the gate line 24 with other one of the pair of second line sections 24B.
(8) In the above (7), the test lines 30 may not be included or the test line 30 and the gate connection line may be connected to the first end portion 24B1 of the second line section 24B.
(9) In the above (7), instead of the gate driver circuit, a pair of gate drivers may be disposed to sandwich the display area AA in the X-axis direction.
(10) The material of the semiconductor film used for the semiconductor section 22D may be polysilicon (LTPS) or amorphous silicon.
(11) The opposed substrate 20 and the array substrate 21 may include a glass substrate instead of the resin substrate.
(12) The opposed substrate 20 may not include color filters and perform black-and-white display (gray scale display).
(13) The electronic paper display 10 may be an electronic powder fluid display, an electrowetting display, or a cholesteric liquid crystal display.
(14) Display panels other than the electronic paper display 10 (such as liquid crystal panels and an organic EL display panels) may be used.

1. A display device comprising:
a display area in which an image is displayed;
a non-display area in which no image is displayed;
a first line extending along a first direction in the display area and the non-display area, the first line being a portion of a first conductive film; and
a second line extending in the non-display area along a second direction that crosses the first direction, the second line being a portion of the first conductive film that is different from the portion of the first conductive film, wherein
the first line includes a first line section that is disposed in the display area and a second line section that is disposed in the non-display area and is continuous to the first line section,
the second line section includes a first end portion, a first width portion, and a second width portion,
the first end portion is spaced from the second line in the first direction,
the first width portion is closer to the first line section with respect to the first direction than the first end portion is, and
the second width portion is continuous to the first width portion and narrower than the first width portion.

2. The display device according to claim 1, further comprising:
a third line disposed in the display area and extending along the second direction; and
a first insulating film included in a layer upper than the first conductive film, wherein
the third line is a portion of a second conductive film that is included in a layer upper than the first insulating film and the third line crosses the first line section via the first insulating film,
the first insulating film includes a first contact hole in a portion that overlaps the third line and the first line section, and
the third line and the first line section are connected via the first contact hole.

3. The display device according to claim 1, further comprising:
a test line disposed in the non-display area and extending along the first direction and transmitting a test signal; and
a first insulating film included in a layer upper than the first conductive film, wherein
the second line includes a pair of second lines, the test line includes a pair of test lines, and the second line section includes a pair of second line sections,
each of the pair of second lines, the pair of test lines, and the pair of second line sections is disposed to sandwich the display area with respect to the first direction,
the pair of second line sections include first end portions,
the pair of test lines are portions of a second conductive film that is included in a layer upper than the first insulating film,
the pair of test lines crosses the pair of second lines via the first insulating film, respectively, and includes second end portions overlapping the first end portions,
the first insulating film includes second contact holes in portions that overlap the first end portions and the second end portions, respectively, and
the first end portions and the second end portions are respectively connected via the second contact holes.

4. The display device according to claim 1, wherein the first line section includes a third width portion and a fourth width portion that is continuous to the third width portion and narrower than the third width portion.

5. The display device according to claim 4, further comprising:
a fourth line disposed in the display area and extending along the second direction; and
a first insulating film included in a layer upper than the first conductive film, wherein
the fourth line is a portion of a second conductive film included in a layer upper than the first insulating film, and
the fourth line crosses the fourth width portion via the first insulating film.

6. The display device according to claim 1, wherein
the first width portion includes first width portions and the second width portion includes second width portions, and
the first width portions and the second width portions are arranged alternately in the first direction.
